(19) United States
(12) Patent Application Publication
(10) Pub. No.: US 2011/0149201 A1
(43) Pub. Date: Jun. 23, 2011

(54) LIGHTGUIDE ILLUMINATOR EMBEDDED DISPLAY

(76) Inventors: Karlton David Powell, Lake Stevens, WA (US); Nenad Nestorovic, Seattle, WA (US)

(21) Appl. No.: 12/905,115

(22) Filed: Oct. 15, 2010

Related U.S. Application Data
(60) Provisional application No. 61/279,107, filed on Oct. 16, 2009.

(51) Int. Cl. G02F 1/13357

(52) U.S. Cl. 349/62

(57) ABSTRACT

A polymer-dispersed liquid crystal based display is embedded inside a lightguide illuminator sheet which provides illumination of the display without the need for a backlight or frontlight. Light from one or more light sources is coupled into the lightguide sheet and is guided within a range of high angles of incidence within the sheet by total internal reflection. The guided light illuminating portions of the display which are in diffusing state is scattered such that some of the light is allowed to escape total internal reflection, providing visibility of the display. Guided light illuminating portions of the display which are in non-diffusing state remains guided within the lightguide illuminator sheet. Combining multiple lightguide embedded displays can be used to provide a three-dimensional display. When a low refractive index cladding is applied to the surfaces of the lightguide embedded display, the display is robust in a dirty environment, and/or can be laminated to adjacent lightguide embedded displays. The use of one or more coupled light sources, such as light emitting diodes, provides color by combining one or more colored light sources or by time-sequentially driving one or more colored light sources. The lightguide illuminator embedded display may further be used as a content dependent active backlight for an LCD display panel to provide improved dynamic contrast.

This utility patent application is based on the U.S. provisional patent application (Ser. No. 61/279,107) filed on Oct. 16, 2009.

### BACKGROUND OF THE INVENTION

1. Field of the Invention

The present invention relates to a slim form factor display embedded inside an optical lightguide illuminator sheet, or a display combined with an optical lightguide illuminator sheet in such a way that the display serves as a display embedded inside an optical lightguide illuminator sheet, and a system that uses the lightguide embedded display for a display device.

2. Description of the Related Art

While a variety of solid-state display devices have been developed in the past, Liquid Crystal Displays (LCDs) are attractive due to low cost, reliability, low power and voltage requirements, longevity, and availability. As a display source however, LCDs require a separate illumination source. Typical fluorescent backlights, such as cold-cathode fluorescent (CCFL), have high voltage requirements and relatively short lifespans. In addition, much of the light from fluorescent backlighting exhibits high angular frequencies that can contribute to scatter, potentially reducing display system contrast. Due to the advantages of solid-state performance, reduced size, low voltage and power requirements, long life, and the increased performance in color gamut, light emitting diodes (LEDs) have gained attention for use in display applications. Arrays of light sources, such as CCFLs or LEDs, have been used in displays, but typically are used as a backlight for a display panel, such as an LCD panel. For a frontlight, arrays of sources typically cannot be placed directly in front of the display panel, since these sources are not transparent, and thus would block the display content from the viewer, so sources are typically placed significantly in front of the display, further increasing the volume requirements and thickness of the display system.

U.S. Pat. No. 6,906,762 discloses a system that uses multiple layers of LCDs that can be selectively made transparent for use in a three-dimensional display system. A backlight is required in order to view the content of each screen in low light conditions. In addition, such type displays may require considerable control of the backlight angular subtense of light to avoid content overlap and screen to screen crosstalk issues when viewing at higher viewing angles.

FIG. 1 is an illustration of a three-dimensional display system in the prior art, disclosed in U.S. Pat. No. 5,764,317, that uses a plurality of electrically switchable layers of polymer dispersed liquid crystal such that an ordinary index of refraction of the nematic liquid crystal substantially matches that of the host polymer when a voltage is applied across the electrically-switchable polymer dispersed liquid crystal film. Light is scattered at the host polymer/nematic liquid crystal interface when a voltage is not applied across the said film, in order to form a three-dimensional display. In so doing, display pixel information can be made to appear to the viewer to emanate from any of the display panels layers switched to a diffusing, or scattering, state. A disadvantage of this embodiment is that a projector is required in order to provide backlight to the volumetric display layers, thus substantially increasing system thickness.

U.S. Pat. No. 5,341,231 discloses a liquid crystal device comprising a liquid crystal display element, a light guide plate, a light source, and a collimator, wherein the display element is composed of a transparent substrate, a counter substrate disposed oppositely to the transparent substrate and having a reflecting means to reflect incident light entering transparent substrate side, with liquid crystal layer interposed therebetween. While this invention does disclose use of a light guide disposed at the transparent substrate side of the liquid crystal element, the display provided cannot provide see-through means since the counter substrate reflects the incident light. Further, a light source is disposed at the edge of the light guide plate, requiring additional width to the physical size of the display beyond that of the active display region. The requirement of a transparent substrate and a light guide on the transparent substrate side of the liquid crystal element increases complexity of the display system unnecessarily as it requires two distinct substrates in order to provide functionality. In addition, while a lamp may provide adequate uniformity as a light source for small display form factors, applications requiring large area, thin form factor displays may suffer disadvantage when not using an array of light sources, such as in the case of using LEDs. This invention does not address the use of arrays of light sources along any one of the edges of the light guide in order to provide improved uniformity, especially for the case of large area displays.

U.S. Pat. No. 7,527,411 discloses a double-sided emitting backlight unit in order to provide illumination to a first liquid crystal display panel while also providing illumination to a second liquid crystal display panel disposed on a second emitting side opposite that of the first emitting side of the double-sided backlight. However, this invention requires multiple light-emitting surfaces of prisms having grooves, and thus may exhibit too high a level of complexity as well as cost for large area and low cost display systems requiring a double-sided backlight.

### SUMMARY OF THE INVENTION

It is an object of the present invention to provide a polymer-dispersed liquid crystal display embedded inside a lightguide illuminator sheet which provides illumination of the display without the need for a backlight or frontlight as is typically required for display illumination in prior art.

It is an object of the present invention to provide a means to form a lightguide embedded display from a display panel by optical wetting of said display with a lightguide illuminator in such a way to form a display embedded inside a lightguide illuminator.

It is an object of the present invention to provide a lightguide illuminator embedded display that is a see-through display.

It is an object of the present invention to provide a lightguide illuminator embedded display that is a partially see-through display.

It is an object of the present invention to provide a lightguide illuminator embedded display that is a non-see-through display.

It is an object of the present invention to provide a lightguide embedded display that uses one or more colored light sources to enable a color display.

It is an object of the present invention to provide a lightguide embedded display that time-sequentially drives one or more colored light sources in conjunction with video content so as to enable a multi-color display.

It is an object of the present invention to provide a lightguide embedded display made of non-planar and/or flexible material thereby enabling a display which can have a curved surface.

It is an object of the present invention to provide lightguide embedded display that may be manufactured in a relatively inexpensive manner.

It is an object of the present invention to provide a lightguide embedded display that uses low refractive index cladding in order to provide display robustness in the elements of weather and/or a dirty environment.

It is another object of the present invention is to provide a slim form factor two-dimensional display system comprised of at least one light source, at least one lightguide optical illuminator, and at least one embedded display panel.

It is another an object of the present invention is to provide a three-dimensional display system comprised of two or more lightguide embedded displays.

It is further an object of the present invention is to provide a display system which uses a lightguide illuminator embedded display as a single-sided emitting or double-sided emitting active addressable backlight.

These and other objects of the invention are met by a lightguide illuminator embedded display disclosed herein designed to couple light from one or more light sources, guide said light within a lightguide illuminator, and scatter said light illuminating portions of display embedded inside of or wetted against the lightguide illuminator that exhibit a scattering state.

The lightguide illuminator embedded display is comprised of at least one or more light sources, one or more lightguide illuminators, and one or more displays. The light sources are coupled into the lightguide illuminator such that coupled light has sufficiently high angle of incidence, above that of the critical angle of the optical media of the lightguide, such that the coupled light is guided within the lightguide illuminator by total internal reflection (TIR). While edge-coupling may be used, the disadvantage of additional width required of the physical size of the display beyond that of the active display region may be reduced by use of side coupling of the light sources. A display comprises a plane or surface that contains an array of scattering and/or non-scattering pixels and/or regions, the pixels or regions being active or passive, the array containing an ordered array of pixels or a layout of shaped regions by design. Active pixels or regions can be electrically driven to be in a diffusing, or scattering, state or be in a non-diffusing, or non-scattering, state, such as in the case of a polymer-dispersed liquid crystal display, while passive pixels or regions are fixed statically in a scattering state. The display is embedded within the lightguide illuminator by wetting of the display to the lightguide illuminator or by lamination of the display within one or more sheets comprising the lightguide illuminator. Wetting serves as optical contact of the display to the lightguide illuminator and enables light guided within the lightguide to illuminate the display at high angles of incidence, further including the display within the guiding bounds of the lightguide so that the display is optically embedded within the lightguide. Lamination of a subsequent lightguide layer on the opposing side of the display can serve to add protection of the display layer. The guided light that illuminates diffusing pixels or regions of the display is scattered in many directions such that a portion of the illuminating light escapes TIR, having angle below that of the critical angle, and transmits to the viewer's eye, while a portion of the illuminating light having angle above that of the critical angle remains guided within the lightguide illuminator until it is scattered by a subsequent diffusing pixel or region of the embedded display. Non-diffusing pixels or regions are optically transparent and non-scattering, and thus provide means for the lightguide illuminator embedded display to be see-through such that a viewer can see through the display regions that are non-diffusing, providing a see-through display.

By further adding a low refractive index optically transparent cladding layer on the outer viewing surfaces of the lightguide illuminator embedded display, optical performance of the display can be maintained when it is placed in a dirty environment. The cladding serves to maintain guiding of the light by maintaining critical angle at all positions across the lightguide illuminator so that extraction of light from the lightguide illuminator due to presence of beads of water or oil on the external surfaces of the lightguide illuminator does not occur. Cladding layers can be used in conjunction with two or more lightguide illuminator embedded displays in order to provide a three-dimensional (3-D) display. In such case of 3-D display, the low refractive index of the cladding layer, such as an air gap or a low-index optical media, serves to provide optical isolation of the lightguiding capability of each lightguide illuminator embedded display. If an air gap is used for optical isolation of the lightguide illuminator embedded displays, an anti-reflection coating can be applied to the outer surfaces of each lightguide illuminator embedded display in order to limit Fresnel reflections from either light transmitted from adjacent displays or from ambient light surrounding the display.

The inventors have discovered that by noting fold symmetry in a lightguide illuminator embedded display, a non-see-through lightguide illuminator embedded display can be formed by placing a reflective layer on or substantially near one side of the display layer, the side opposing the lightguide illuminator. The reflective layer reflectivity can be a broadband reflector or can be wavelength sensitive or partially reflective. In such case, the display is similarly embedded within the guiding of the lightguide illuminator, but any light that illuminates a diffusing pixel or region and is scattered in such a way that escapes TIR on the display side having the added reflective layer is reflected back into the display layer and rescattered, thus increasing brightness of the display toward the viewing side of the non-see-through lightguide illuminator embedded display.

In addition to the use of a lightguide illuminator embedded display providing a display visible to a viewer, the inventors have discovered that such a lightguide illuminator embedded display disclosed herein provides a few key advantages over traditional displays, that include providing an illuminated display that does not require a traditional backlight or frontlight, providing a see-through display that is compact and having slim form factor, and providing a 3-D display that is compact. The see-through display provided by the invention disclosed herein can be used as head-up display (HUD) applications as well as signage applications. In a HUD application, the lightguide illuminator embedded display may be embedded within the windscreen of an automobile, or laminated to the windscreen, or provide a separate display system that may be placed on the dashboard or control console nearby the windscreen. Use of multiple lightguide illuminator embedded displays provided by the invention disclosed herein can be used in 3-D display applications, as a direct-view 3-D display or as a display component used in conjunction with viewing optics. The non-see-through display provided by the invention disclosed herein can be used as automobile console displays as well as mobile phone and wrist-worn displays.

### DESCRIPTION OF THE DRAWINGS

FIG. 1 is an illustration of a 3-D display system found in the prior art that uses multiple PDLC display panels in conjunction with a projector having image content used as a backlight.

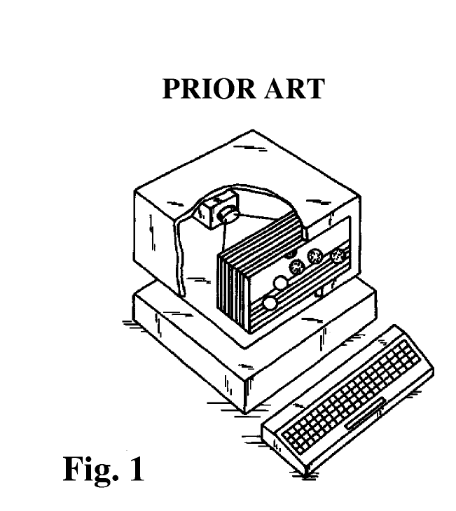

FIG. 2 illustrates a see-through lightguide illuminator embedded display formed using a display layer disposed between a substrate and lightguide.

FIG. 3 illustrates a see-through lightguide illuminator embedded display formed using a discrete display having substrate and cover, wetted to a lightguide illuminator.

FIG. 4 illustrates a see-through lightguide illuminator embedded display having low refractive index cladding layers on outer surfaces.

FIG. 5 illustrates a lightguide illuminator embedded display having a partially reflective layer on or near the display layer.

FIG. 6 illustrates a lightguide illuminator embedded display formed by wetting or laminating a discrete partially reflective display, having substrate, cover, and partially reflective layer on or near the display layer, to a lightguide illuminator.

FIG. 7 illustrates a 3-D display comprised of two or more lightguide illuminator embedded displays.

FIG. 8 illustrates various source collection optics methods that can be used in order to collect light into an angular width appropriate for coupling into the lightguide illuminator.

FIG. 9 illustrates various source coupling optics methods that can be used in order to couple light collected by collection optics into the lightguide illuminator.

FIG. 10 illustrates a lightguide illuminator embedded display disposed between two display panel stacks in order to provide a double-sided emitting active addressable backlight.

FIG. 11 illustrates a lightguide illuminator embedded display disposed adjacent to a display panel stack in order to provide a single-sided emitting active addressable backlight.

### DETAILED DESCRIPTION

The following Detailed Description further describes concepts and discloses specific details of the preferred embodiments in order to provide a thorough understanding of claimed subject matter. However, those skilled in the art will understand that the claimed subject matter may be practiced without these specific details. In other instances, the description may not describe in detail well-known methods, processes, procedures, components and/or sub-components.

Referring to the accompanying Figs. there is shown a lightguide illuminator embedded display 100 that provides a viewable display that can be seen from both sides of the display. It should be noted that the lightguide illuminator embedded display 100 can function for a continuum of wavelengths of visible light as well as ultraviolet, infrared, far-infrared, and other radiation wavelength ranges, depending on the choice of material used to form the collection optics 12, coupling optics 14, lightguide illuminator 15, display substrate 19, and display media 21. Further, it should be noted that choice of a lightguide material exhibiting substantially high transparency and limited dispersion throughout a given spectrum provides for a lightguide illuminator embedded display that functions substantially consistent for all wavelengths within such wavelength spectrum. For such case, the display functions substantially independent of wavelength of the source or sources to be coupled into the lightguide.

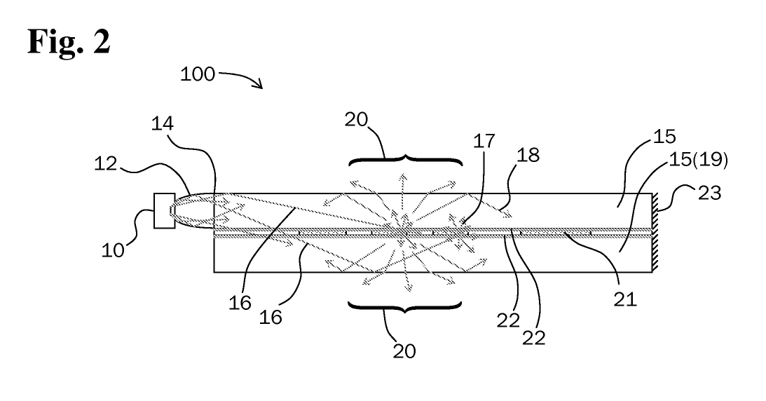

Referring now to FIG. 2, a diagram of a lightguide illuminator embedded display 100 to provide a slim form factor see-through display in accordance with one or more embodiments will be discussed. Referring to FIG. 2, the lightguide illuminator embedded display 100 comprises one or more light sources 10, one or more collection optics 12, one or more coupling optics 14, one or more lightguide illuminators 15, and a display layer 21 that is placed between transparent conductive layers 22. An optional reflective layer 23 can be placed at the edges of the lightguide illuminator that are not being used for coupling of the light sources. In more detail, still referring to the invention of FIG. 2, light emitted by one or more light sources 10 is collected into a limited angle, or angular subtense, using one or more collection optics 12, then coupled into lightguide illuminator 15 using coupling optics 14. The guided light 16 exhibits high angles of incidence and is kept from escaping the exit faces of lightguide illuminator 15 due to total internal reflection. Total internal reflection (TIR) occurs within the lightguide illuminator 15 for angles of light that are lower than the critical angle as defined in Equation 1,

$${θ}_{c} = {sin}^{- 1} ( \frac{{n}_{2}}{{n}_{1}} ) \qquad 1 )$$

where θ_{c} is the critical angle from surface normal to the lightguide outer surfaces, n₂ is the refractive index of the less optically dense media beyond the outer surfaces of the lightguide illuminator 15, and n₁ is the refractive index of the more optically dense media of the lightguide illuminator 15. When guided light 16 illuminates embedded display layer 21 having array of pixels or regions in diffusing state, the light is scattered in many directions from the locations of these diffusing pixels or regions such that a portion of the scattered light 17 exhibits angles below the critical angle and is allowed to escape TIR, thus escape lightguide illuminator 15 and/or display substrate 19, as viewable display light 20, while other portions of the scattered light 17 exhibit higher angles and are reflected and recycled by the lightguide illuminator 15 until illuminating a subsequent display layer 21 in diffusing state. By using either polymer dispersed liquid crystal (PDLC) or polymer network liquid crystal (PNLC) as the display layer 21, between two optically transparent conductive layers 22 having a patterned array of pixels or regions appropriately designed in order to provide an electric field across the two transparent conductive layers 22 so as to provide switchable diffusing properties of the said pixels or regions when applying a voltage across these portions of the patterned transparent conductive layers 22. In one or more embodiments, it may be noted that the array of pixels or regions may contain an ordered array of pixels or a layout of shaped regions by design. Active pixels or regions can be electrically driven to be in a diffusing, or scattering, state or be in a non-diffusing, or non-scattering, state, such as in the case of a polymer-dispersed liquid crystal display, while passive pixels or regions are fixed statically in a scattering state. The thickness of as well as the voltage across display layer 21 is of sufficient thickness to enable the driving voltage, driven by display drive electronics, across the electrodes of transparent conductive layers 22 to drive the display layer between a diffusing state and a non-diffusing state. Further, both passive and active regions may be combined in the same display layer 21.

In one or more embodiments, still referring to the invention of FIG. 2, the optical media used to comprise collection optics 12, coupling optics 14, and lightguide illuminator 15 are sufficiently transparent for the wavelengths of light sources 10 being used. Collection numerical aperture (NA) and exit face size of the collection optics 12 is sufficiently contained so as to provide a reasonably high level of coupling efficiency of the light into the lightguide illuminator 15, which can typically range from 30% to 70% in some embodiments. The lightguide illuminator 15 is of sufficient thickness to accept the output of the coupling optics 14, which can be on order of 0.5 mm to 4 mm thickness in some embodiments. Note that while light is shown coupled in from one edge of the lightguide illuminator, light can be coupled from any of the available edges of the lightguide illuminator 15. Further, reflective layer 23 can be used to further improve light recycling capability of the lightguide illuminator 15 by reflecting light that would have escaped back into the lightguide for a subsequent pass, increasing efficiency of usage of the light sources 10. In another embodiment, the lightguide illuminator embedded display 100 is non-planar. However, the scope of the claimed subject matter is not limited in these respects.

In one embodiment, light sources 10 may be comprised of one or more light-emitting diodes (LEDs), or one or more arrays of LEDs, and driven with constant drive current as can be the case for a monochromatic display, which may further provide for dimming by addition of adjustability of the drive current level to adjust output intensity of light sources 10. In another embodiment, light sources 10 may be comprised of one or more LEDs, or one or more arrays of LEDs, and may be driven by pulse width modulation (PWM) in order to be able to adjust dimming in the case of use of sources of the same color, or to adjust color in the case of using light sources 10 comprising different colored light sources when using more than one light source. In a further embodiment, light sources 10 may be driven time-sequentially and in synchronization with changes in display content such that the apparent color and position of diffusing pixels or regions within display layer 21 is controlled by timing between the pulsed signal or signals driving the sources and the signals driving the pixels or regions within display layer 21. In such way, it is possible to form a full color display by providing red, green, and blue light sources as light sources 10, and time-sequentially illuminating three or more sub-frames in display layer 21, such that each sub-frame content represents the discrete color components needed to form a full color full frame of the video content used as input to the display driver which in tern drives the display layer pixels or regions in display layer 21, as well as timing of the time sequential signals driving the light sources 10. In yet another embodiment, the lightguide illuminator embedded display 100 may also include wavelength selective coatings or films on viewable display light 20 side outer surfaces of lightguide illuminator embedded display 100. However, the scope of the claimed subject matter is not limited in these respects. In yet still another embodiment, video or controller driver circuitry may be disposed on one of the substrates disposed against display layer 21, such as lightguide illuminator 15 and/or display substrate 19.

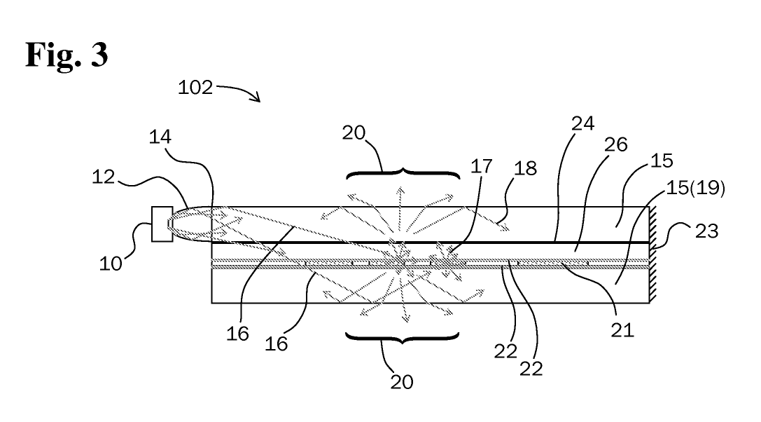

Referring now to FIG. 3, the lightguide illuminator embedded display 102 can be comprised of a lightguide illuminator 15, having light sources 10 and collection optics 12 and coupling optics 14, wetted against one or more discrete display layers 21 having substrate 19 and cover sheet 26. In such case that a display panel, such as a PDLC panel, provides for a cover sheet 26, it is still possible to embed the display within the lightguide illuminator 15 by wetting the display cover sheet 26, such as by lamination layer 24, such as with an optically transparent adhesive. In such instance, the display layer 21 in the embodiment shown in FIG. 3 optically behaves in a similar manner having similar light guiding and scattering properties as if it were an embedded display as in the case shown in FIG. 2. For instance, when guided light 16 illuminates embedded display layer 21 having array of pixels or regions in diffusing state, the light is scattered in many directions from the locations of these diffusing pixels or regions such that a portion of the scattered light 17 exhibits angles below the critical angle and is allowed to escape TIR, thus escape lightguide illuminator 15 and/or display substrate 19, as viewable display light 20, while other portions of the scattered light 17 exhibit higher angles and are reflected and recycled by the lightguide illuminator 15 until illuminating a subsequent display layer 21 in diffusing state. In yet another embodiment, the lightguide illuminator embedded display 102 may also include wavelength selective coatings or films on viewable display light 20 side outer surfaces of lightguide illuminator embedded display 102. It should be noted that while the simplest form of the cross section of the display layer 21 is flat and having uniform thickness across the display, display layer 21 is not limited to being flat, and may include a substantially non-flat periodic and/or aperiodic profile, such as a sawtooth profile or facetted profile, while substantially maintaining thickness of said display layer 21 versus position across the display. Residual scatter at high angles may be varied by use of such parameters including non-flat profile of display layer thus relative direction of electric-field relative to lightguide plane and/or surface, orientation of dispersed liquid crystal within binder matrix and use of polarized light, and control of the angular distribution profile of the guided light 16 coupled into the lightguide illuminator 15, to improve scattering efficiency of viewable display light.

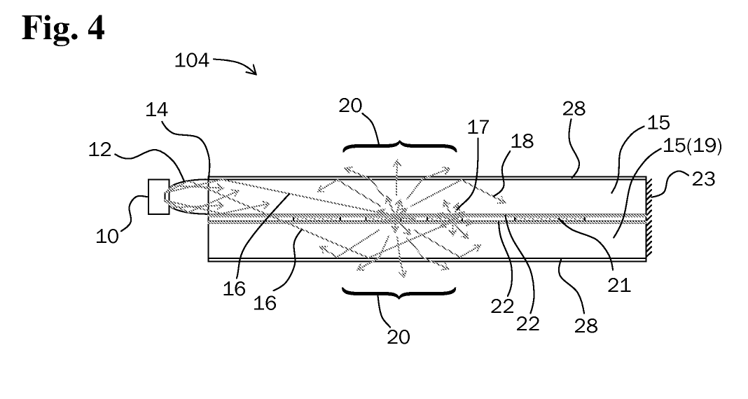

Referring now to FIG. 4, by applying cladding layer 28 including low refractive index optical media to the outer surfaces of the lightguide illuminator 15 to the embodiment shown in FIG. 2, lightguide illuminator embedded display 104 can be made robust for use in a dirty environment. Lightguide illuminator embedded display 104 includes a lightguide illuminator 15, having low index cladding 28 applied to outer surfaces and having light sources 10 and collection optics 12 and coupling optics 14, one or more discrete display layers 21 placed between two or more patterned transparent conductive layers 22. In such case that optically transparent cladding layers 28 are included on the outer viewing surfaces of the lightguide illuminator embedded display 104, optical performance of the display can be maintained when placed in a dirty environment since the cladding layers 28 serve to maintain guiding of the light by maintaining critical angle at all positions across the lightguide illuminator 15 so that extraction of light from the lightguide illuminator 15 due to presence of beads of water or oil on the external surfaces of the lightguide illuminator 15 does not occur.

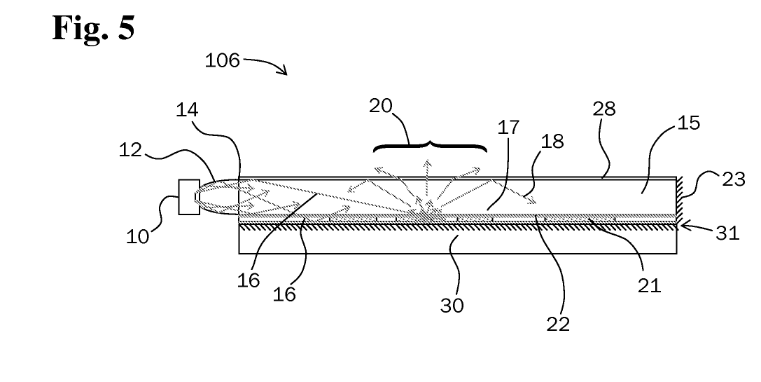

Referring now to the embodiment shown in FIG. 5, by using electrically conductive reflective coated substrate 30 as the display substrate disposed substantially near or against display layer 21 such that display layer 21 is placed in between electrically conductive reflective coated substrate 30 and patterned transparent conductive layer 22, a non-see-through lightguide illuminator embedded display 106 is formed, when electrically conductive layer 31 exhibits high reflectivity of the wavelengths of light provided by the light sources. While the electrically conductive layer 31 on reflective coated substrate 30 can be electrically conductive and thus serve as the conductive electrode for the reflective side of the display layer 21, it is understood that a similar effect could be achieved by a combination of an optically reflective layer that is not as electrically conductive in conjunction with a transparent conductive layer 22 or a non-transparent conductive layer serving as the electrically conductive reflective surface of reflective substrate 30. When an optically reflective layer that is not as electrically conductive is used in conjunction with a transparent conductive layer 22, the transparent conductive layer 22 may be disposed between the optically reflective layer and display layer 21 or disposed at a side of the optically reflective layer opposed to that of the display layer 21. When an optically reflective layer that is not as electrically conductive is used in conjunction with a non-transparent conductive layer, the optically reflective layer may be disposed between display layer 21 and the non-transparent conductive layer. For instance, an interference type coating, such as a layered thin-film dichroic coating, or layered polymer film may provide high reflectivity while being used in conjunction with an electrically conductive yet transparent Indium Tin Oxide (ITO) layer. The spacing of as well as the voltage across display layer 21 is of sufficient thickness to enable the driving voltage across the electrodes of conductive reflective substrate 30 and transparent conductive layer 22 to drive the display layer between a diffusing state and a non-diffusing state. Light is guided between the viewing surface of lightguide illuminator 15 and the reflective layer of conductive reflective substrate 30. It should be noted that in some embodiments, the drive electronics appropriate to drive the array of pixels or regions of display layer 21 may be part of conductive reflective substrate 30 and/or the substrate of lightguide illuminator 15 that may have transparent conductive layer(s) 22 applied thereon. It should also be noted that it is desirable to maintain close proximity of the reflective layer of conductive reflective substrate 30 to the display layer 21 in order to maintain resolvability of the display. As the distance of separation between conductive reflective substrate 30 and display layer 21 increases, light is allowed to reflect at a greater distance from the display layer 21 such that a lateral translation in position of the light may make the display light 20 appear to originate from a non-diffusing pixel or region of display layer 21, thus lowering display contrast appearance to the viewer for light exiting as viewable display light 20. It should be noted that the display contrast provided by a non-see-through lightguide illuminator embedded display 106 disclosed herein, may be higher than that provided by more traditional means of using frontlight illumination due to the fact that for the guided light case described herein only illumination light that is scattered from a pixel or region in diffusing state may scatter and allow exit of the guided light to viewable display light 20, whereas use of more traditional frontlight illumination would suffer from ambient reflections of the input light in at least one angle, due to simple law of reflection, providing significant advantage in display contrast for the non-see-through lightguide illuminator embedded display 106. In one embodiment, the thickness of the display layer 21 may be in the range of 1 to 5 microns. In a further embodiment, a cladding layer 28 may be applied to at least one of the surfaces of the lightguide illuminator 15. However, while such cladding layer 28 provides additional benefit to robustness in a dirty environment by maintaining performance of the display in presence of such elements as water or oil, it will be obvious to one skilled in the art that said cladding layer 28 is not necessary for function of the display in relatively clean environment conditions. In yet another embodiment, the lightguide illuminator embedded display 106 may also include a wavelength selective coating or film on viewable display light 20 side outer surface of lightguide illuminator embedded display 106. However, the scope of the claimed subject matter is not limited in these respects.

Still referring to FIG. 5, it is interesting to note that when electrically conductive layer 31 exhibits partial reflectivity of the wavelengths of light provided by the light sources 10, lightguide illuminator embedded display 106 may provide a partially see-through lightguide illuminator embedded display 106. In such instance, electrically conductive layer 31 may be comprised of a neutral density filter, such as a metalized type film having an optical density, so as to provide both partial reflectivity of the wavelengths of the light sources 10 as well as provide electrical conductivity. In another embodiment, a wavelength selective coating, such as a dichroic or rugate interference type coating, or a polymer layered film, may be used in conjunction with a substantially transparent electrically conductive layer to comprise electrically conductive layer 31. Wavelength selective reflectivity and/or partial reflectivity provided by interference type coatings and films may include notch, multi-notch, band-pass, long-pass and short-pass coatings and/or films.

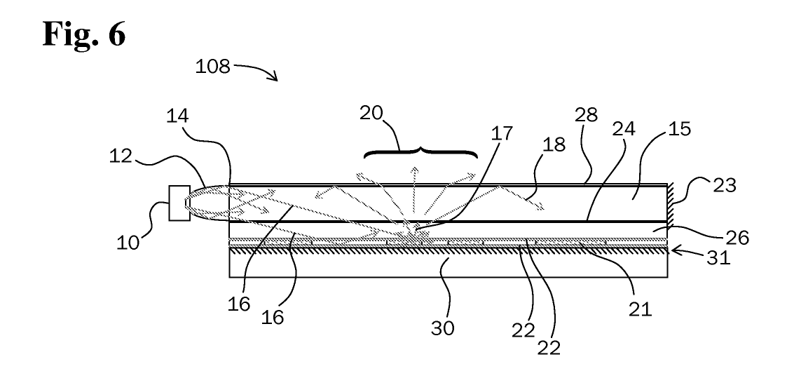

Referring now to the embodiment shown in FIG. 6, non-see-through lightguide illuminator embedded display 108 may be comprised of a lightguide illuminator 15, having light sources 10 and collection optics 12 and coupling optics 14, wetted against one or more discrete display layers 21 having conductive reflective substrate 30 and cover sheet 26. In such case that a display panel, such as a reflective PDLC panel, provides for a cover sheet 26, it is still possible to embed the display within the lightguide illuminator 15 by wetting the display cover sheet 26, such as by lamination layer 24, such as with an optically transparent adhesive. In such instance, the display layer 21 in the embodiment shown in FIG. 6 optically behaves in a similar manner having similar light guiding and scattering properties as if it were an embedded display as in the case shown in FIG. 5. In one embodiment, electrically conductive layer 31 may comprise a metalized coating. In another embodiment, electrically conductive layer 31 may comprise a combination of a partially reflective coating or film, such as a neutral density coating or wavelength selective coating, and a transparent electrically conductive layer 22. In yet another embodiment, the lightguide illuminator embedded display 108 may also include a wavelength selective coating or film on viewable display light 20 side outer surface of lightguide illuminator embedded display 108.

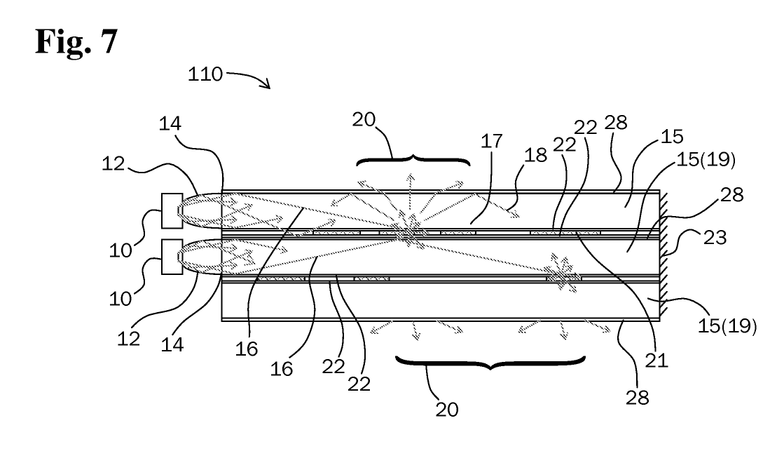

Referring now to the embodiment shown in FIG. 7, cladding layers can be used in conjunction with two or more lightguide illuminator embedded displays 100 and/or 102 and/or 106 and/or 108 in order to provide a three-dimensional (3-D) display 110. In such case of 3-D display 110, the low refractive index of the cladding layer 28, such as an air gap or a low-index optical media, serves to provide optical isolation of the lightguiding capability of each lightguide illuminator embedded display 100 and/or 102 and/or 106 and/or 108. In such way, colors of each pixel or region within each display layer in the stack of lightguide illuminator embedded displays comprising the 3-D display can be controlled by appropriately driving the light sources 10 and display layers 21 associated with each optically isolated lightguide illuminator embedded display 100 and/or 102 and/or 106 and/or 108 included within the 3-D display 110. Drive of the display layers 21 and light sources 10 in each lightguide illuminator embedded display 100 and/or 102 included within 3-D display 110 may include constant drive current, adjustable drive current, pulse width modulation, and/or time sequential driving of voltage and/or current, or any combination thereof regarding the drive control of the display layer 21, having adjacent transparent conductive layers 22, and the light sources 10. In such a way, the color and spatial position of each diffusing pixel or region of each display layer 21 may be controlled to provide an active and/or passive display having content that appears to be 3-dimensional to the viewer of viewable display light 20. Color and spatial position of each diffusing pixel or region of each display layer 21 and across each display layer 21 within each of the two or more lightguide illuminator embedded displays comprising the 3-D display 110 may be addressed and controlled by a controller that drives the desired display content for each of the lightguide illuminator embedded displays 100 and/or 102 and/or 106 and/or 108, while z depth position of each diffusing pixel or region of each display layer 21 may be addressed and controlled by a controller that drives the desired display content for one or more particular lightguide illuminator embedded displays 100 and/or 102 and/or 106 and/or 108 comprising the 3-D display 110. Note that the 3-D display system described herein exhibits an advantage of being capable of displaying more than one z depth position for a given xy position across the 3-D display 110, such that the display may be viewed at many angles without loss of integrity of the three-dimensional aspect of the display appearance. If an air gap is used for optical isolation of the lightguide illuminator embedded displays 100 and/or 102, an anti-reflection coating can be applied to the outer surfaces of each lightguide illuminator embedded display 100 and/or 102 and/or 106 and/or 108 in order to limit Fresnel reflections from either light transmitted from adjacent displays or from ambient light surrounding the 3-D display 110. In one embodiment, the low refractive index cladding layer may include a fluoropolymer sheet, such as Teflon, or copolymer such as fluorinated ethylene propylene (FEP). In still another embodiment, porous silicone may be used to achieve a low refractive index. In a further embodiment, a non-see-through lightguide illuminator embedded display 106 and/or 108 is combined with one or more see-through lightguide illuminator embedded displays 100 and/or 102 and/or 104 in order to provide a 3-D display 110. However, the scope of the claimed subject matter is not limited in these respects.

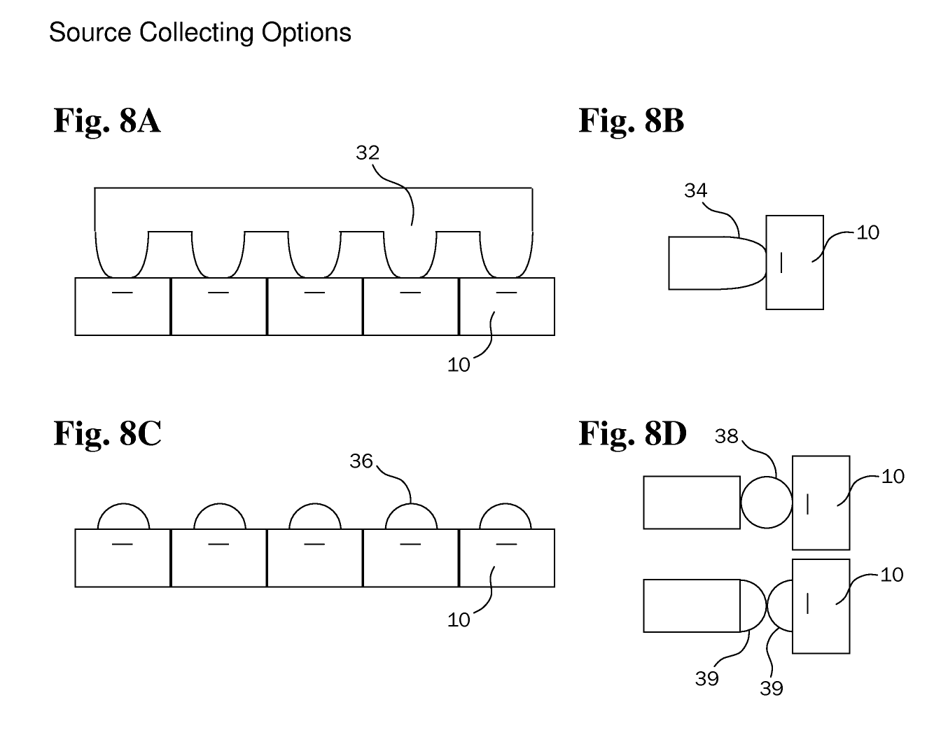

Referring now to FIGS. 8A, 8B, 8C, and 8D, in one or more embodiments, collection optics 12 may exhibit a one-dimensional profile, such as a one-dimensional compound parabolic collector (CPC) collection optics 34 shown in FIG. 8B, while in another embodiment collection optics 12 may comprise an array of one or more two-dimensional collection optics 32, such as one or more compound parabolic collectors (CPCs) as shown in FIG. 8A. In another embodiment, light collection optics 12 may comprise an array of dome lenses 36 each aligned with a light source as shown in FIG. 8C, while in a further embodiment collection optics 12 may comprise one or more cylindrical lenses 38 and/or 39 as shown in FIG. 8D. However, the scope of the claimed subject matter is not limited in these respects.

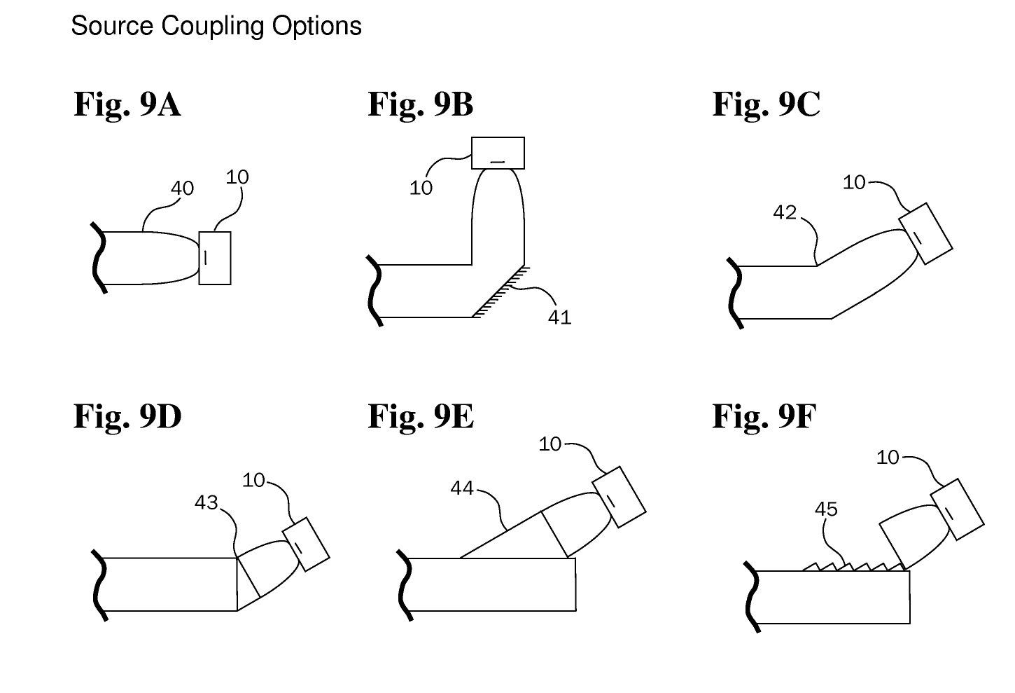

Referring now to FIGS. 9A, 9B, 9C, 9D, 9E, and 9F, in one or more embodiments, coupling optics 14 may exhibit coupling of collected light into lightguide by lightguide edge 40, so as to provide edgelit coupling as shown in FIG. 9A, while in another embodiment, collected light may be edgelit using a 90 degree bend and a reflective layer 41 as shown in FIG. 9B. Note that although edgelit coupling is shown with a coupling optic in FIG. 9A, the coupling optic is not required for cases where the light source extent and etendue is of sufficient small size in order to be accepted by the acceptance etendue of the lightguide illuminator 15. In another embodiment of FIG. 9C, edgelit coupling may be provided for by using bend 42 prior to or as part of lightguide illuminator 15, while in another embodiment, a similar effect of bend 42 of FIG. 9C is achieved by prism 43 in FIG. 9D. Further embodiments may include side-lit coupling using prism 44 as part of or bonded to lightguide illuminator 15 as shown in FIG. 9E, or side-lit coupling using prismatic array 45 as part of or bonded to lightguide illuminator 15. It should be noted that one disadvantage of edgelit coupling is that additional width is required of the physical size of the display beyond that of the active display region. One advantage of the invention disclosed herein includes use of side coupling of the light sources in order to allow a higher fill factor of active display region to the display physical size. However, the scope of the claimed subject matter is not limited in these respects.

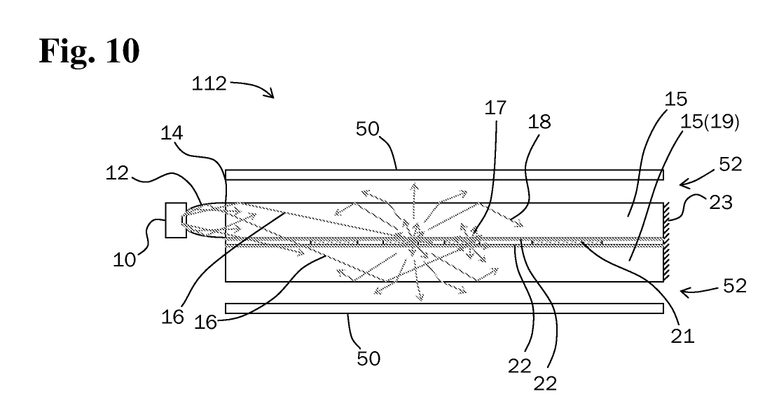

Referring now to the embodiment shown in FIG. 10, a lightguide illuminator embedded display 100 and/or 102 may be utilized as a double-sided emitting active backlight for double-sided display system 112. Double-sided display system 112 includes two display panel stacks 50, each of which may include a liquid crystal display panel with two polarizers, diffuser sheet(s), and brightness enhancement film(s), as would be expected from a typical display panel stack. Isolation layers 52 each may include either an air gap and/or a low refractive index cladding material.

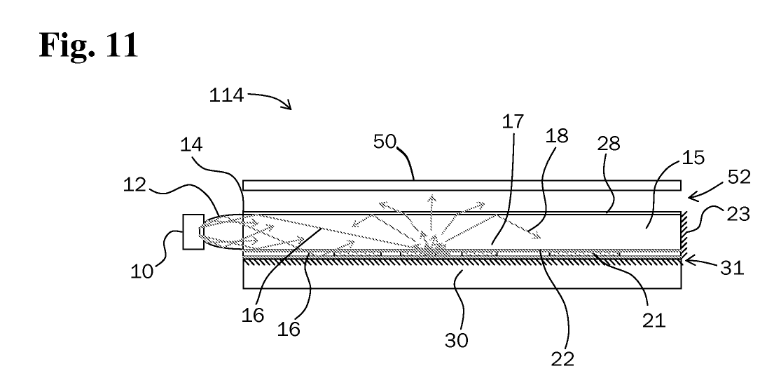

Referring now to the embodiment shown in FIG. 11, a lightguide illuminator embedded display 106 and/or 108 may be utilized as a single-sided emitting active backlight for a single-sided display system 114. Single-sided display system 114 includes one display panel stack 50, which may include a liquid crystal display panel with two polarizers, diffuser sheet(s), and brightness enhancement film(s), as would be expected from a typical display panel stack. Isolation layer 52 may include either an air gap and/or a low refractive index cladding material. By controlling the location of the diffuse pixels and/or regions of the single-sided backlight using a controller, light can be efficiently output to locations across the panel such that the backlight may provide more light in areas of the display panel stack 50 where the content requires higher brightness, and less light in areas of the display panel stack 50 where the content requires less brightness. By controlling where the light is allowed to escape from the backlight based on video content of the video controller of the display panel stack it is possible to increase the dynamic range of the display, within limits or constraints of the response time of the display layer 21 media. It should be noted as an example that both polymer dispersed liquid crystal and polymer network liquid crystal, which may be used for display layer 21, may exhibit enhanced frequency response by adding dopants to increase said response times and/or use of faster cure times so as to form smaller droplet sizes of liquid crystal within the binder matrix.

While the foregoing Detailed Description provides specific example embodiments and methods to describe the scope and spirit of the present invention, it should be understood to one of ordinary skill that the present invention disclosed herein is not limited to specific variations and/or combinations of the various system configurations, processes, functions, and features described herein, as the scope and subject matter of the invention includes all equivalents thereof. It will be apparent by the foregoing description that changes to the arrangement and/or construction of elements may be made without departing from the scope and subject matter of the present invention.

We claim:

1. A see-through lightguide illuminator embedded display comprising one or more light sources, one or more collection optics, one or more coupling optics, one or more lightguide illuminators, a display layer, and a transparent display substrate, said display layer having switchable diffuse state and/or non-diffuse state pixels and/or regions, said display layer electrically controlled using and disposed between two transparent conductive layers, one of the said transparent conductive layers disposed thereon said transparent display substrate, such that guided light may be scattered into viewable display light, providing illumination of the display without the need for a backlight or frontlight.

2. A see-through lightguide illuminator embedded display of claim 1, where the transparent display substrate is a lightguide illuminator.

3. A see-through lightguide illuminator embedded display of claim 1, wherein the light sources coupled into the light guide are light-emitting diodes.

4. A see-through lightguide illuminator embedded display of claim 1, wherein the display layer includes polymer-dispersed liquid crystal media and/or polymer network liquid crystal media.

5. A see-through lightguide illuminator embedded display of claim 1, wherein a portion of the diffuse state and/or non-diffuse state pixels and/or regions are non-switchable, such that said non-switchable diffuse state pixels and/or regions comprise volume scattering media, scattering guided light into viewable display light, while said non-switchable non-diffuse state pixels and/or regions comprise non-scattering transparent media.

6. A see-through lightguide illuminator embedded display of claim 1, where the outer surfaces of the lightguide illuminator embedded display are substantially planar.

7. A see-through lightguide illuminator embedded display of claim 1, where the lightguide illuminator embedded display is substantially non-planar, such that the outer surfaces of the display have three-dimensional shape.

8. A see-through lightguide illuminator embedded display of claim 1, where the lightguide illuminator embedded display is flexible.

9. A see-through lightguide illuminator embedded display of claim 1, where the light coupled into the lightguide exhibits a constrained and/or limited angular exit profile.

10. A see-through lightguide illuminator embedded display of claim 1, wherein the cross section of the display layer has a substantially non-flat profile, said display layer having substantially uniform thickness versus position across the display, said non-flat profile improving scattering efficiency of viewable display light.

11. A see-through lightguide illuminator embedded display of claim 1, wherein the orientation of the extraordinary axis of the liquid crystal within the display layer is substantially aligned at an angular direction relative to the normal of the display layer surface and propagation direction of the coupled light in the lightguide, so as to improve display contrast.

12. A see-through lightguide illuminator embedded display of claim 11, wherein the light coupled into the light guide illuminator is substantially polarized.

13. A see-through lightguide illuminator embedded display of claim 1, wherein said one or more light sources are multiplexed in time with the drive signal of said electrically controlled display layer, so as to form a field sequential color display.

14. A see-through lightguide illuminator embedded display of claim 1, where cladding layers, having refractive index lower than the refractive index of the lightguide media, are disposed on outer surfaces of said lightguide illuminator embedded display, so as to provide display robustness in the elements of weather and/or a dirty environment.

15. A partially see-through or non-see-through lightguide illuminator embedded display comprising one or more light sources, one or more collection optics, one or more coupling optics, one or more lightguide illuminators, a display layer, and a display substrate, said display layer having switchable diffuse state and/or non-diffuse state pixels and/or regions, said display layer electrically controlled using and disposed between a transparent conductive layer and a reflective or partially reflective electrically conductive layer, said reflective or partially reflective electrically conductive layer disposed thereon said display substrate, such that guided light may be scattered into viewable display light, providing illumination of the display without the need for a frontlight.

16. A lightguide illuminator embedded display of claim 15, wherein said one or more light sources are multiplexed in time with the drive signal of said electrically controlled display layer, so as to form a field sequential color display.

17. A lightguide illuminator embedded display of claim 15, where cladding layers, having refractive index lower than the refractive index of the lightguide media, are disposed on at least one of the outer surfaces of said lightguide illuminator embedded display, so as to provide display robustness in the elements of weather and/or a dirty environment.

18. A lightguide illuminator embedded display of claim 15, wherein a portion of the diffuse state and/or non-diffuse state pixels and/or regions are non-switchable, such that said non-switchable diffuse state pixels and/or regions comprise volume scattering media, scattering guided light into viewable display light, while said non-switchable non-diffuse state pixels and/or regions comprise non-scattering transparent media.

19. A lightguide illuminator embedded display of claim 15, where the lightguide illuminator embedded display comprises an emitting active backlight, capable of increasing dynamic range of a transmissive display when used in conjunction with said transmissive display by providing, actively over time, relatively higher backlight illumination into display regions containing brighter pixels and relatively lower backlight illumination for display regions containing darker pixels.

20. A three-dimensional display comprising one or more optical isolation layers, having low refractive index, in conjunction with two or more lightguide illuminator embedded displays in order to provide a three-dimensional viewable display, said lightguide illuminator embedded displays comprising: one or more light sources, one or more collection optics, one or more coupling optics, one or more lightguide illuminators, a display layer, and a reflective, partially reflective, or transparent display substrate, said display layer having switchable diffuse state and/or non-diffuse state pixels and/or regions, said display layer electrically controlled using and disposed between a transparent conductive layer and a reflective or partially reflective or transparent electrically conductive layer, said reflective or partially reflective or transparent electrically conductive layer disposed thereon said display substrate, such that guided light may be scattered into viewable display light, providing illumination of the display without the need for a frontlight.
